(19) United States
(12) Patent Application Publication
(10) Pub. No.: US 2026/0129383 A1
(43) Pub. Date: May 7, 2026

(54) AUDIO QUALITY TEST METHOD AND APPARATUS

(71) Applicant: BEIJING XIAOMI MOBILE SOFTWARE CO., LTD., Beijing (CN)

(72) Inventor: Bin WANG, Beijing (CN)

(21) Appl. No.: 19/116,304

(22) PCT Filed: Sep. 30, 2022
(86) PCT No.: PCT/CN2022/123642

§ 371 Date: Mar. 27, 2025

(51) Int. Cl. H04R 29/00

(52) U.S. Cl. CPC H04R 29/00

(57) ABSTRACT

An audio quality test method, performed by a first device, includes: acquiring a first audio signal, in which the first audio signal corresponds to a first signal format; acquiring a second audio signal related to a second device, in which the second audio signal corresponds to a second signal format; and testing audio quality of the second device according to the first signal format, the second signal format, the first audio signal, and the second audio signal.

### CROSS-REFERENCE TO RELATED APPLICATIONS

This application is the US national phase application of International Application No. PCT/CN 2022/123642 filed on Sep. 30, 2022, the entire contents of which are incorporated herein by reference.

### TECHNICAL FIELD

The present disclosure relates to the field of wireless communication technologies, and in particular to an audio quality test method and apparatus.

### BACKGROUND

Due to increased used demand for high-quality audio and improved performance of a terminal, current terminals in wireless communication networks may generally provide a three-dimensional audio service based on three signal formats, i.e., a signal of a channel, a signal of an object, and a signal of a scenario. A plurality of microphones may be configured in the terminal, and an audio signal format collected by the plurality of microphones may a single-channel signal, a stereo signal, or a binaural signal, a 5.1 multi-channel signal, a first-order ambisonic signal (FOA), a high-order ambisonic signal (HOA), and the like. When the terminal establishes a communication link with a remote device, the format of the audio signal that may be selected by the terminal may be any one of the foregoing audio signal formats, different end-to-end audio solutions are established for the audio signals in the different signal formats, and audio quality that may be provided by testing the different end-to-end audio solutions is a main basis for finally selecting which format audio signal to be adopted.

In related art, an original monophonic signal is usually used as a reference signal for an analyzer to calculate the audio quality, resulting in that the test process can only be directed to a single-channel audio end-to-end test scheme, and cannot be suitable for testing audio quality of audio signal end-to-end test schemes in multiple signal formats that are not the single-channel.

### SUMMARY

In a first aspect, the embodiments of the present disclosure provide an audio quality test method. The method is performed by a first device, and includes:
acquiring a first audio signal, in which the first audio signal corresponds to a first signal format;
acquiring a second audio signal related to a second device, in which the second audio signal corresponds to a second signal format; and
testing audio quality of the second device according to the first signal format, the second signal format, the first audio signal, and the second audio signal.

In a second aspect, the embodiments of the present disclosure provide another audio quality test method. The method is performed by a second device, and includes:
determining, according to a first audio signal, a second audio signal related to the second device, in which the first audio signal corresponds to a first signal format, the second audio signal corresponds to a second signal format, and the first signal format, the second signal format, the first audio signal, and the second audio signal are used to test audio quality of the second device.

In a third aspect, the embodiments of the present disclosure provide another audio quality test method. The method is performed by a third device, and includes:
determining, according to a first audio signal, a second audio signal related to a second device, in which the first audio signal corresponds to a first signal format, the second audio signal corresponds to a second signal format, and the first signal format, the second signal format, the first audio signal, and the second audio signal are used to test audio quality of the second device.

In a fourth aspect, the embodiments of the present disclosure provide a first device, which includes a processor, and a memory in which a computer program is stored. The processor is configured to perform the method described in the first aspect above.

In a fifth aspect, the embodiments of the present disclosure provide a second device, which includes a processor, and a memory in which a computer program is stored. The processor is configured to perform the method described in the second aspect above.

In a sixth aspect, the embodiments of the present disclosure provide a third device, which includes a processor, and a memory in which a computer program is stored. The processor is configured to perform the method described in the third aspect above.

### BRIEF DESCRIPTION OF THE DRAWINGS

In order to more clearly illustrate the technical solutions in the embodiments of the present disclosure or the background, the drawings required to be used in the embodiments of the present disclosure or the background are described below.

FIG. 1 is a schematic architectural diagram of a communication system according to an embodiment of the present disclosure.

FIG. 2 is a schematic flowchart of an audio quality test method applicable to a first device according to an embodiment of the present disclosure.

FIG. 3 is a schematic flowchart of another audio quality test method according to an embodiment of the present disclosure.

FIG. 4 is a schematic flowchart of another audio quality test method according to an embodiment of the present disclosure.

FIG. 5 is a schematic flowchart of another audio quality test method according to an embodiment of the present disclosure.

FIG. 6a is a schematic flowchart of another audio quality test method according to an embodiment of the present disclosure.

FIG. 6b is a schematic flowchart of another audio quality test method according to an embodiment of the present disclosure.

FIG. 7 is a schematic flowchart of another audio quality test method according to an embodiment of the present disclosure.

FIG. 8 is a schematic flowchart of another audio quality test method according to an embodiment of the present disclosure.

FIG. 9 is a schematic flowchart of another audio quality test method according to an embodiment of the present disclosure.

FIG. 10 is a schematic flowchart of an audio quality test method applicable to a second device according to an embodiment of the present disclosure.

FIG. 11 is a schematic flowchart of another audio quality test method according to an embodiment of the present disclosure.

FIG. 12 is a schematic flowchart of another audio quality test method according to an embodiment of the present disclosure.

FIG. 13 is a schematic flowchart of an audio quality test method applicable to a third device according to an embodiment of the present disclosure.

FIG. 14 is a schematic flowchart of another audio quality test method according to an embodiment of the present disclosure.

FIG. 15 is a schematic flowchart of another audio quality test method according to an embodiment of the present disclosure.

FIG. 16 is a schematic flowchart of an audio quality test method applicable to a communication system according to an embodiment of the present disclosure.

FIG. 17 is a schematic flowchart of another audio quality test method according to an embodiment of the present disclosure.

FIG. 18 is a flowchart of an uplink test method according to an embodiment of the present disclosure.

FIG. 19 is a flowchart of another uplink test method according to an embodiment of the present disclosure.

FIG. 20 is a flowchart of a downlink test method according to an embodiment of the present disclosure.

FIG. 21 is a flowchart of another downlink test method according to an embodiment of the present disclosure.

FIG. 22 is a schematic structural diagram of a communication apparatus according to an embodiment of the present disclosure.

FIG. 23 is a schematic structural diagram of a communication apparatus according to an embodiment of the present disclosure.

FIG. 24 is a schematic structural diagram of a chip according to an embodiment of the present disclosure.

### DETAILED DESCRIPTION

Embodiments of the present disclosure are described in detail below, and examples of the embodiments are shown in the accompanying drawings, in which the same or similar reference numerals throughout represent the same or similar elements or elements having the same or similar functions. The implementations described in the following embodiments do not represent all implementations consistent with the embodiments of the present disclosure. Instead, they are merely examples of apparatuses and methods consistent with some aspects of the embodiments of the present disclosure as detailed in the appended claims.

The terms used in the embodiments of the present disclosure are merely for the purpose of describing particular embodiments, and are not intended to limit the embodiments of the present disclosure. The singular forms “a” and “the” used in the embodiments of the present disclosure and the appended claims are also intended to include plural forms, unless the context clearly indicates other meanings. It should also be understood that the term “and/or” as used herein refers to and includes any or all possible combinations of one or more associated listed items.

It should be understood that although the terms “first”, “second”, “third”, etc. may be used in the embodiments of the present disclosure to describe various information, these information should not be limited to these terms. These terms are only used to distinguish the same type of information from each other. For example, without departing from the scope of the embodiments of the present disclosure, the first information may also be referred to as second information, and similarly, the second information may also be referred to as first information. Depending on the context, the word “if” as used herein may be interpreted as “when”, “in a case that”, or “in response to determining that”.

For ease of understanding, the terms involved in the present disclosure are first introduced.

1. Uplink

The uplink refers to a physical channel of a signal from a terminal to a network device, and may be composed of mobile phone transmit power, a human body loss, a building loss, a path loss, an antenna gain, a diversity gain, a feeder and other losses, a duplexer loss, a splitter loss, base station receiver sensitivity, and the like.

2. Downlink

The downlink refers to a physical channel of a signal from a network device to a terminal, and may be composed of a base station transmitter, a combiner, a duplexer, a feeder and other losses, an antenna gain, a path loss, a building loss, a human body loss, mobile phone receiving sensitivity, and the like.

In order to better understand an audio quality test method disclosed in the embodiments of the present disclosure, the following first describes a communication system to which the embodiments of the present disclosure are applicable.

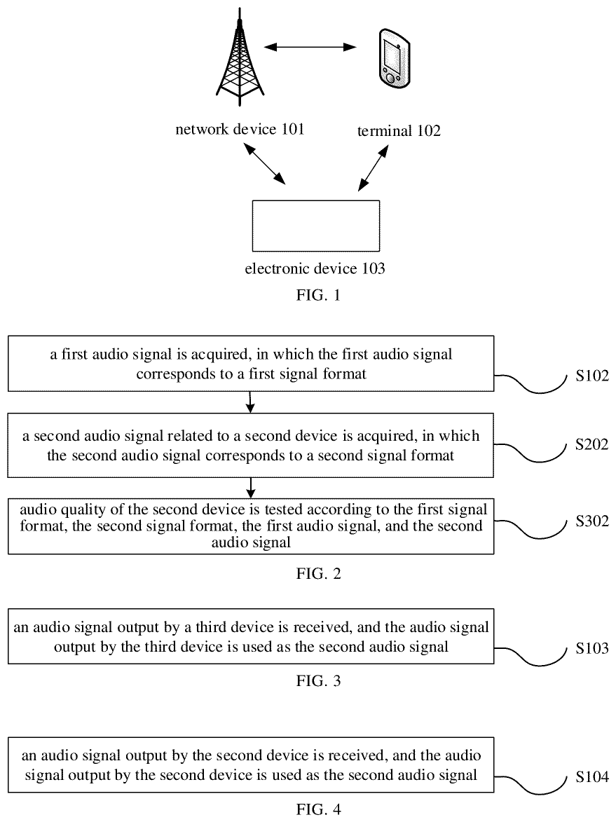

FIG. 1 is a schematic architectural diagram of a communication system according to an embodiment of the present disclosure. The communications system may include, but is not limited to, a network device, a terminal, and an electronic device having a test function, the number and the forms of devices shown in FIG. 1 are only used for example and do not constitute a limitation on the embodiments of the present disclosure, and the actual application may include two or more network devices, two or more terminals, two or more electronic devices having a test function. The communications system shown in FIG. 1 includes a network device 101, a terminal 102, and an electronic device 103 having a test function.

It should be noted that the technical solutions of the embodiments of the present disclosure is applicable to various communication systems. For example, a long term evolution (LTE) system, a 5th generation (5G) mobile communication system, a 5G new radio (NR) system, another future new mobile communication system, or the like.

The network device 101 in the embodiments of the present disclosure is an entity for transmitting or receiving a signal on a network. For example, the network device 101 may be an evolved base station (eNB), a transmission reception point (TRP), a next generation nodeB (gNB) in an NR system, a base station in another future mobile communication system, or an access node in a wireless network (Wi-Fi™) system. A specific technology and a specific device form used by the network device are not limited in the embodiments of the present disclosure.

The network device provided in the embodiments of the present disclosure may be composed of a centralized unit (CU) and a distributed unit (DU), in which the CU may also be referred to as a control unit. The CU-DU structure may be used to split a protocol layer of the network device, such as a base station, and part of the functions the protocol layer are placed in the CU for centralized control, and part or all of the remaining functions of the protocol layer are distributed in the DU, and the DU is centrally controlled by the CU.

The terminal 102 in the embodiments of the present disclosure is an entity for receiving or transmitting a signal on a user side, for example, a mobile phone. The terminal may also be referred to as a terminal device, a user equipment (UE), a mobile station (MS), a mobile terminal device (MT), etc. The terminal may be a car with communication function, a smart car, a mobile phone, a wearable device, a tablet computer (Pad), a computer with wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in a smart city, a wireless terminal device in a smart home, etc.

The electronic device 103 in the embodiments of the present disclosure is an electronic device for performing test analysis on the received data. For example, the electronic device 103 may be an analyzer used to analyze audio quality.

A specific technology and a specific device form used by the terminal are not limited in the embodiments of the present disclosure.

It can be understood that the communication system described in the embodiments of the present disclosure is intended to describe the technical solutions of the embodiments of the present disclosure more clearly, does not constitute a limitation on the technical solutions provided in the embodiments of the present disclosure, and it can be known by those of ordinary skill in the art that, as the evolution of the system architecture and the appearance of the new service scenario, the technical solutions provided in the embodiments of the present disclosure are also applicable.

The audio quality test method and apparatus provided by the present disclosure will be described in detail below with reference to the accompanying drawings. FIG. 2 is a schematic flowchart of an audio quality test method according to an embodiment of the present disclosure. The method is performed by a first device. The audio quality test method in this embodiment is applicable to the first device, for example, any electronic device having a test function, which is not limited in the present disclosure.

As shown in FIG. 2, the method may include but is not limited to the following steps.

S102, a first audio signal is acquired, in which the first audio signal corresponds to a first signal format.

An audio signal is a signal representing a mechanical wave, and is an information carrier for wavelength and intensity change of the mechanical wave. The first audio signal may refer to an audio signal that is not processed by the audio quality test method, which for example, may be a song, a news audio, or the like, which is not limited in the present disclosure. That is, in the embodiments of the present disclosure, the first audio signal may be processed by the audio quality test method to obtain a processed audio signal, and then audio quality of a second device is tested with reference to the obtained processed audio signal.

The first signal format refers to a signal format corresponding to the first audio signal, which for example, may be a single-channel, a stereo, a binaural signal, or the like.

S202, a second audio signal related to a second device is acquired, in which the second audio signal corresponds to a second signal format.

The second device may refer to a terminal that may provide an audio service, such as a mobile phone or a tablet, which is not limited in the present disclosure.

The second audio signal refers to an audio signal related to the second device, for example, may be an audio signal obtained by the second device through processing.

The second signal format refers to a signal format corresponding to the second audio signal, and the second signal format may be the same as or different from the first signal format, which is not limited in the present disclosure.

S302, audio quality of the second device is tested according to the first signal format, the second signal format, the first audio signal, and the second audio signal.

It can be understood that the content indicated by the first audio signal and the second audio signal may be the same, and therefore, the audio quality test may be performed based on the first audio signal and the second audio signal. The different audio signal formats may affect the audio quality test process, so that when the audio quality test is performed in combination with the first signal format and the second signal format, the reliability of the test process can be effectively improved.

In this embodiment, In this embodiment, by acquiring the first audio signal, in which the first audio signal corresponds to the first signal format, acquiring the second audio signal related to the second device, in which the second audio signal corresponds to the second signal format, and testing the audio quality of the second device according to the first signal format, the second signal format, the first audio signal, and the second audio signal, the signal format of the first audio signal and the signal format of the second audio signal can be effectively combined in the audio quality test process to adapt to the application scenario where the end-to-end audio solution is located, thereby effectively improving the test effect on the audio quality of the second device.

An embodiment of the present disclosure further provides an audio quality test method, in which the first signal format includes at least one of: a channel-based signal format, an object-based signal format, and a scenario-based signal format. In this way, the applicability of the audio quality test process to different signal formats of the first signal can be effectively improved.

For example, an immersive voice and audio service (IVAS) codec being standardized by the 3GPP SA4 is capable of supporting encoding and decoding requirements of the above three signal formats. The specific signal format in the three signal formats may include:
a channel-based signal: a single-channel signal, a stereo signal, a binaural signal, a 5.1 or 7.1 surround signal, a 5.1.4 or 7.1.4 three-dimension (3 Dimension) signal, in which “0.4” represents a height-channel signal;
a scenario-based signal: a first order ambisonics (FOA), a second order high ambisonics (HOA2), a third order high ambisonics (HOA3);
an object-based signal: an audio data, a metadata, etc.

The embodiments of the present disclosure further provide an audio quality test method, in which the second signal format includes at least one of: the channel-based signal format, the object-based signal format, and the scenario-based signal format, so that the audio quality test process can effectively address the audio signals in different formats provided by the second device, thereby effectively improving the audio quality test effect on the second device.

That is, in the embodiments of the present disclosure, the second device to be subjected to the audio quality test may provide the three-dimensional audio service based on the signal format of the channel, the signal format of the object, and the signal format of the scenario.

FIG. 3 is a schematic flowchart of another audio quality test method according to an embodiment of the present disclosure. The audio quality test method in this embodiment is applicable to a first device, as shown in FIG. 3, the method may include but is not limited to the following steps.

S103, an audio signal output by a third device is received, and the audio signal output by the third device is used as the second audio signal.

The audio signal output by the third device is obtained by receiving an uplink audio signal sent by the second device and processing the uplink audio signal by the third device.

The third device may be a network device or a peer terminal, which may be, for example, a simulator.

The uplink audio signal refers to an audio signal obtained based on an uplink (from the second device to the third device).

That is, in this embodiment of the present disclosure, the audio quality of the uplink and downlink for the second device may be separately tested through the third device, and in the uplink, the second device may transmit the uplink audio signal to the third device, and the third device receives the uplink audio signal output by the second device, and then processes the uplink audio signal, and outputs the processed audio signal to the first device, so that the first device may receive the audio signal output by the third device, to use the audio signal output by the third device as the second audio signal related to the second device.

In an embodiment of the present disclosure, the third device may receive the uplink audio signal sent by the second device through an antenna, and then decode and render the uplink audio signal to obtain the second audio signal, and send the second audio signal to the first device.

In this embodiment, the audio signal output by the third device is received, and the audio signal output by the third device is used as the second audio signal, in which the audio signal output by the third device is obtained by the third device through receiving the uplink audio signal sent by the second device and processing the uplink audio signal, thereby providing reliable data support for the audio quality test process of the uplink audio signal corresponding to the second device, so as to effectively improve the pertinence for the uplink audio signal in the test process.

It can be understood that the embodiment may be implemented alone or in combination with other embodiments of the present disclosure. For example, this embodiment may be implemented in conjunction with the embodiment shown in FIG. 2.

FIG. 4 is a schematic flowchart of another audio quality test method according to an embodiment of the present disclosure. The audio quality test method in this embodiment is applicable to a first device. As shown in FIG. 4, the method may include but is not limited to the following steps.

S104, an audio signal output by the second device is received, and the audio signal output by the second device is used as the second audio signal.

The audio signal output by the second device is obtained by receiving a downlink audio signal sent by a third device and processing the downlink audio signal by the second device.

The downlink audio signal refers to an audio signal obtained based on a downlink (from the third device to the second device).

For example, the second device may receive the downlink audio signal sent by the third device through an antenna, and perform operations such as audio signal decoding and audio signal rendering to obtain the second audio signal.

In this embodiment, the audio signal output by the second device is received, and the audio signal output by the second device is used as the second audio signal, in which the audio signal output by the second device is obtained by the second device through receiving the downlink audio signal sent by the third device and processing the downlink audio signal, thereby providing reliable data support for the audio quality test process of the downlink audio signal corresponding to the second device, so as to effectively improve the pertinence for the downlink audio signal in the test process.

It can be understood that this embodiment may be implemented alone or in combination with other embodiments of the present disclosure. For example, this embodiment may be implemented in conjunction with the embodiment shown in FIG. 2.

That is, the audio quality test method provided in the embodiments of the present disclosure may formulate a corresponding quality test solution for the uplink audio signal and the downlink audio signal, respectively, to effectively improve the applicability of the audio quality test process.

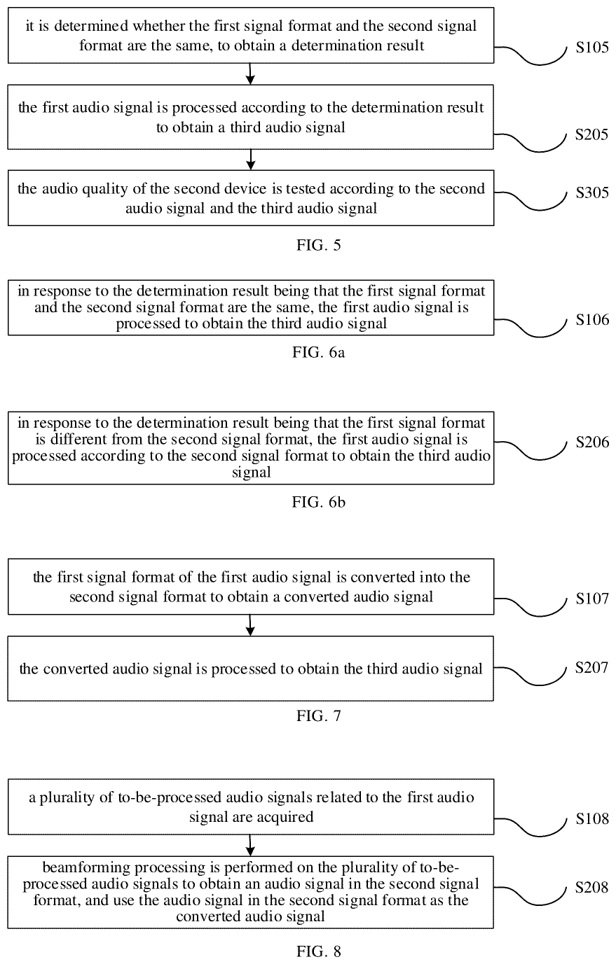

FIG. 5 is a schematic flowchart of another audio quality test method according to an embodiment of the present disclosure. The audio quality test method in this embodiment is applicable to a first device. As shown in FIG. 5, the method may include but is not limited to the following steps.

S105, it is determined whether the first signal format and the second signal format are the same, to obtain a determination result.

It can be understood that, there are many possible types of the first signal format and the second signal format, and whether the first signal format and the second signal format are the same may affect a subsequent audio quality test process, and therefore, when obtaining the determination result by determining whether the first signal format and the second signal format are the same, a reliable reference basis may be provided for subsequent processing of the first audio signal for obtaining a third audio signal.

S205, the first audio signal is processed according to the determination result to obtain a third audio signal.

The third audio signal may refer to an audio signal obtained by processing the first audio signal based on the determination result. The third audio signal may be used as a reference audio signal for the second audio signal in the audio quality test process, for example, the audio quality output by the second device may be determined by comparing the signal quality of the second audio signal with the signal quality of the third audio signal.

S305, the audio quality of the second device is tested according to the second audio signal and the third audio signal.

In this embodiment, it is determined whether the first signal format and the second signal format are the same, the determination result is obtained, the first audio signal is processed according to the determination result to obtain the third audio signal, and the audio quality of the second device is tested according to the second audio signal and the third audio signal, so that the adaptability of the obtained third audio signal to the second audio signal in the audio quality test process can be effectively improved, ensuring the accuracy of the audio quality test result.

It can be understood that this embodiment may be implemented alone or in combination with other embodiments of the present disclosure. For example, this embodiment may be implemented in conjunction with the embodiment shown in FIG. 2.

FIG. 6a is a schematic flowchart of another audio quality test method according to an embodiment of the present disclosure. The audio quality test method in this embodiment is applicable to a first device. As shown in FIG. 6a, the method may include but is not limited to the following steps.

S106, in response to the determination result being that the first signal format and the second signal format are the same, the first audio signal is processed to obtain the third audio signal.

In this embodiment of the present disclosure, when the determination result is that the first signal format and the second signal format are the same, a rendering apparatus may be used to process the first audio signal to obtain the third audio signal.

For example, in a case that the first signal format is the same as the second signal format, the rendering apparatus may be used to perform rendering processing on the first audio signal, for example, some rendering processing manners that enable the first audio signal to be smoother, such as re-optimizing of each frame of the audio signal, which is not limited in the present disclosure.

When the first signal format and the second signal format are the same, the first audio signal may be directly rendered to obtain the third audio signal.

FIG. 6b is a schematic flowchart of another audio quality test method according to an embodiment of the present disclosure. The audio quality test method in this embodiment is applicable to a first device. As shown in FIG. 6b, the method may include but is not limited to the following steps.

S206, in response to the determination result being that the first signal format is different from the second signal format, the first audio signal is processed according to the second signal format to obtain the third audio signal.

In this embodiment of the present disclosure, when the first signal format and the second signal format are different, the audio signal format of the first audio signal may be converted from the first signal format to the second signal format through an audio format conversion module, and then the converted audio is rendered by using a rendering module to obtain the third audio signal, which may ensure that the obtained third audio signal matches the signal format of the second audio signal.

For example, in a case that the first signal format and the second signal format are different, the audio signal format of the first audio signal may be converted from the first signal format to the second signal format through the audio format conversion module first, and then the first audio signal is rendered through the rendering device, for example, some rendering processing manners that enable the first audio signal to be smoother, such as re-optimizing of each frame of the audio signal, which is not limited in the present disclosure.

That is, in this embodiment of the present disclosure, rendering processing may be performed before the third audio signal is generated based on the first audio signal, so that the preprocessing of the third audio signal can be realized, which effectively improves the fluency of the third audio signal in the audio quality test process, and improves the reliability of the audio quality test result.

In this embodiment, when the determination result is that the first signal format and the second signal format are the same, the first audio signal is processed to obtain the third audio signal, and when the determination result is that the first signal format and the second signal format are different, the first audio signal is processed according to the second signal format to obtain the third audio signal, so that the first signal can be flexibly processed according to different determination results in the audio quality test process, to ensure the adaptability of the obtained third audio signal to the second audio signal, thereby effectively improving the reliability and applicability of the obtained third audio signal in the audio quality test process.

It can be understood that this embodiment may be implemented alone or in combination with other embodiments of the present disclosure. For example, this embodiment may be implemented in connection with the embodiments shown in FIG. 2 and FIG. 5.

FIG. 7 is a schematic flowchart of another audio quality test method according to an embodiment of the present disclosure. The audio quality test method in this embodiment is applicable to a first device. As shown in FIG. 7, and the method may include but is not limited to the following steps.

S107, the first signal format of the first audio signal is converted into the second signal format to obtain a converted audio signal.

The converted audio signal refers to an audio signal in the second signal format obtained by performing format conversion processing on the first audio signal.

S207, the converted audio signal is processed to obtain the third audio signal.

In this embodiment, the first signal format of the first audio signal is converted into the second signal format to obtain the converted audio signal, and the converted audio signal is processed to obtain the third audio signal, so that it can be ensured that the signal format of the obtained third audio signal is the same as that of the second audio signal, so that the audio quality test can be performed based on the third audio signal and the second audio signal in the same signal format.

It can be understood that this embodiment may be implemented alone or in combination with other embodiments of the present disclosure. For example, this embodiment may be implemented in conjunction with the embodiments shown in FIG. 2, FIG. 5, and FIGS. 6a and 6b.

FIG. 8 is a schematic flowchart of another audio quality test method according to an embodiment of the present disclosure. The audio quality test method in this embodiment is applicable to a first device. As shown in FIG. 8, the method may include but is not limited to the following steps.

S108, a plurality of to-be-processed audio signals related to the first audio signal are acquired.

The to-be-processed audio signals are obtained by collecting the first audio signal by a corresponding audio collection apparatus.

S208, beamforming processing is performed on the plurality of to-be-processed audio signals to obtain an audio signal in the second signal format, and use the audio signal in the second signal format as the converted audio signal.

The beamforming processing is a combination of antenna technologies and digital signal processing technologies, and may be used for directional signal transmission or reception.

In this embodiment, the plurality of to-be-processed audio signals related to the first audio signal are acquired, in which the to-be-processed audio signals are obtained by collecting the first audio signal by the corresponding audio collection apparatus, the plurality of to-be-processed audio signals are performed with beamforming processing to obtain the audio signal in the second signal format, and the audio signal in the second signal format is used as the conversion audio signal, so that the format conversion of the first audio signal can be implemented, which effectively improves the practicability of the obtained converted audio signal in the audio quality test process.

It can be understood that this embodiment may be implemented alone or in combination with other embodiments of the present disclosure. For example, this embodiment may be implemented in conjunction with the embodiments shown in FIG. 2, FIG. 5, FIG. 6a, FIG. 6b, and FIG. 7.

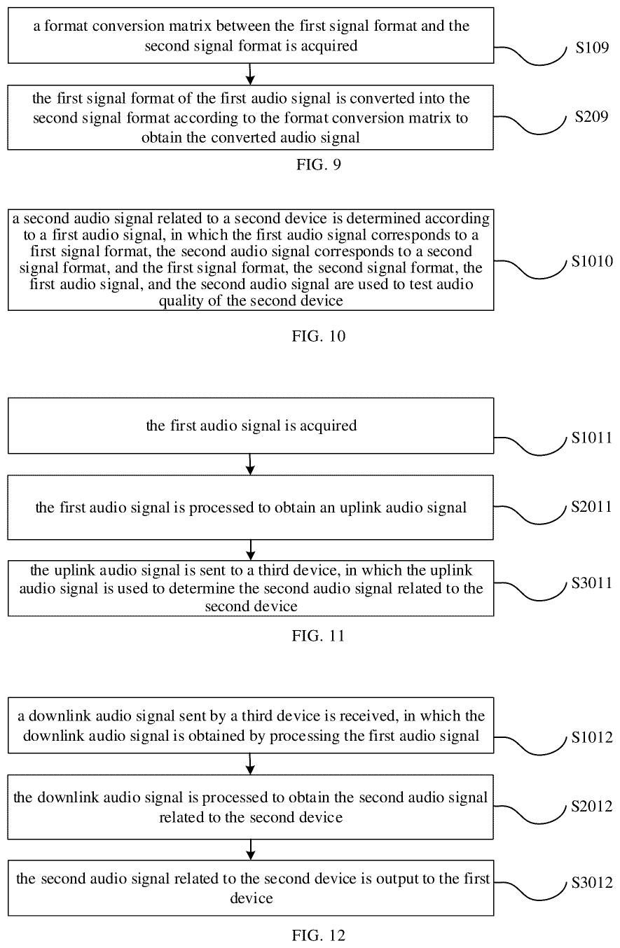

FIG. 9 is a schematic flowchart of another audio quality test method according to an embodiment of the present disclosure. The audio quality test method in this embodiment is applicable to a first device. As shown in FIG. 9, the method may include but is not limited to the following steps.

S109, a format conversion matrix between the first signal format and the second signal format is acquired.

The format conversion matrix refers to a matrix used for format conversion between the first signal format and the second signal format.

S209, the first signal format of the first audio signal is converted into the second signal format according to the format conversion matrix to obtain the converted audio signal.

In this embodiment, the format conversion matrix between the first signal format and the second signal format is acquired, and the first signal format of the first audio signal is converted into the second signal format according to the format conversion matrix to obtain the converted audio signal, so that the format conversion of the first audio signal can be quickly and accurately implemented based on the format conversion matrix, effectively improving the format conversion efficiency and reliability.

It can be understood that this embodiment may be implemented alone or in combination with other embodiments of the present disclosure. For example, this embodiment may be implemented in conjunction with the embodiments shown in FIG. 2, FIG. 5, FIG. 6a, FIG. 6b, and FIG. 7.

That is, in this embodiment of the present disclosure, the third audio signal may be used as a reference signal for audio measurement, and therefore, the third audio signal may also be referred to as a reference audio signal. When the quality test is performed based on the uplink audio signal, if the first signal format is different from the second signal format, there may be two methods for acquiring the third audio signal (also referred to as the reference audio signal):
method 1: using a hardware collection device of a reference structure to collect the first audio signal, converting the first audio signal into the converted audio signal in the second signal format through a reference audio signal format conversion function module, and then processing the converted audio signal through a reference renderer to obtain the reference audio signal;
method 2: using a software algorithm of a reference design to convert the audio signal into the converted audio signal in the second signal format through the reference audio signal format conversion function module, and then processing the converted audio signal through a reference rendering function module to obtain the reference audio signal.

When the first signal format and the second signal format are the same, the first audio signal may be processed by the reference renderer to obtain the reference audio signal.

In the embodiments of the present disclosure, when the quality test is performed based on the downlink audio signal, if the first signal format is different from the second signal format, there may be two methods for acquiring the reference audio signal:
method 1: using a hardware collection device of a reference structure to collect the audio signal, converting the audio signal into the converted audio signal in the second signal format through a reference audio signal format conversion function module, and processing the converted audio signal through a reference renderer to obtain the reference audio signal.
method 2: using a software algorithm of a reference design to convert the audio signal into the converted audio signal in the second signal format through a reference audio signal format conversion function module, and processing the converted audio signal through a reference rendering function module to obtain the reference audio signal.

When the first signal format and the second signal format are the same, the first audio signal may be processed by a reference renderer to obtain the reference audio signal.

In this embodiment of the present disclosure, when calculating the audio signal quality of the to-be-tested device 9 (the second device), it may be that the analyzer device 9 (the third device) obtains the audio signal quality of the to-be-tested device by comparing the audio signal of the to-be-tested device with the reference audio signal.

FIG. 10 is a schematic flowchart of another audio quality test method according to an embodiment of the present disclosure. The audio quality test method in this embodiment is applicable to a second device. As shown in FIG. 10, the method may include but is not limited to the following steps.

S1010, a second audio signal related to a second device is determined according to a first audio signal, in which the first audio signal corresponds to a first signal format, the second audio signal corresponds to a second signal format, and the first signal format, the second signal format, the first audio signal, and the second audio signal are used to test audio quality of the second device.

In this embodiment, the second audio signal related to the second device is determined according to the first audio signal, in which the first audio signal corresponds to the first signal format, the second audio signal corresponds to the second signal format, and the first signal format, the second signal format, the first audio signal, and the second audio signal are used to test the audio quality of the second device, thereby effectively improving the association between the first audio signal and the second audio signal, thereby ensuring the reliability of the audio quality test process.

An embodiment of the present disclosure further provides an audio quality test method, in which the first signal format includes at least one of: a channel-based signal format, an object-based signal format, or a scenario-based signal format. In this way, the applicability of the audio quality test process to different signal formats of the first signal is effectively improved.

An embodiment of the present disclosure further provides an audio quality test method, in which the second signal format includes at least one of: a channel-based signal format, an object-based signal format, or a scenario-based signal format. In this way, the audio quality test process may effectively address the audio signals in different formats provided by the second device, thereby effectively improving the audio quality test effect on the second device.

FIG. 11 is a schematic flowchart of another audio quality test method according to an embodiment of the present disclosure. The audio quality test method in this embodiment is applicable to a second device, as shown in FIG. 11, the method may include but is not limited to the following steps.

S1011, the first audio signal is acquired.

In the embodiments of the present disclosure, when acquiring the first audio signal, the first audio signal may be acquired based on an audio collection apparatus preconfigured in the second device, or may be acquired based on an audio collection apparatus externally connected to the second device, or may be acquired in a wired or wireless connection manner, which is not limited in the present disclosure.

S2011, the first audio signal is processed to obtain an uplink audio signal.

In the embodiments of the present disclosure, the signal format of the obtained uplink audio signal may be the same as or different from the signal format of the first audio signal, which is not limited in the present disclosure.

S3011, the uplink audio signal is sent to a third device, in which the uplink audio signal is used to determine the second audio signal related to the second device.

In this embodiment of the present disclosure, when sending the uplink audio signal to the third device, the uplink audio signal may be sent through an antenna.

In this embodiment, the first audio signal is acquired, the first audio signal is processed to obtain the uplink audio signal, and the uplink audio signal is sent to the third device, in which the uplink audio signal is used to determine the second audio signal related to the second device, so that the correlation between the obtained second audio signal and the first audio signal can be ensured, effectively improving the reliability of the audio quality test process.

It can be understood that this embodiment may be implemented alone or in combination with other embodiments of the present disclosure. For example, this embodiment may be implemented in conjunction with the embodiment shown in FIG. 10.

FIG. 12 is a schematic flowchart of another audio quality test method according to an embodiment of the present disclosure. The audio quality test method in this embodiment is applicable to a second device. As shown in FIG. 12, the method may include but is not limited to the following steps.

S1012, a downlink audio signal sent by a third device is received, in which the downlink audio signal is obtained by processing the first audio signal.

In the embodiments of the present disclosure, the second device may receive the downlink audio signal sent by the third device through an antenna, or in other communication manners, which is not limited in the present disclosure.

S2012, the downlink audio signal is processed to obtain the second audio signal related to the second device.

In the embodiments of the present disclosure, when processing the downlink audio signal to obtain the second audio signal related to the second device, the downlink audio signal may be sequentially decoded and rendered to obtain the second audio signal.

S3012, the second audio signal related to the second device is output to the first device.

In this embodiment, the downlink audio signal sent by the third device is received, in which the downlink audio signal is obtained by processing the first audio signal, the downlink audio signal is processed to obtain the second audio signal related to the second device, and the second audio signal related to the second device is output to the first device, so that the downlink audio signal of the second device can be processed to obtain the second audio signal and the second audio signal is transmitted to the first device, to complete the audio quality test on the second device.

It can be understood that this embodiment may be implemented alone or in combination with other embodiments of the present disclosure. For example, this embodiment may be implemented in conjunction with the embodiment shown in FIG. 10.

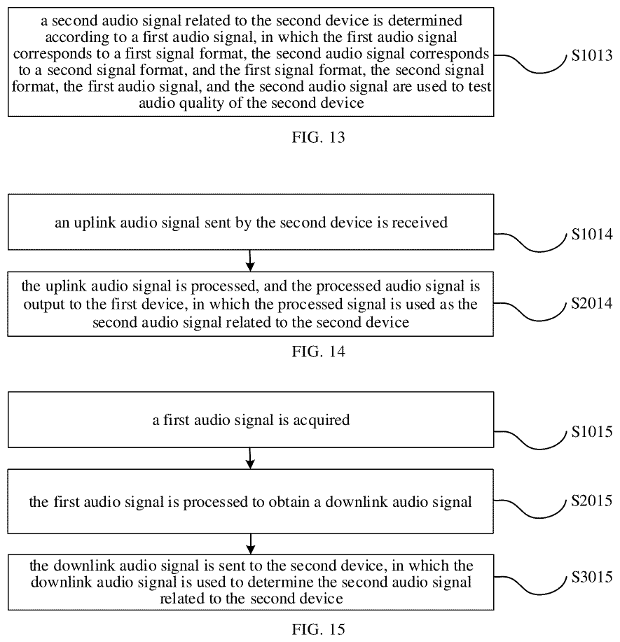

FIG. 13 is a schematic flowchart of another audio quality test method according to an embodiment of the present disclosure. The audio quality test method in this embodiment is applicable to a third device. As shown in FIG. 13, the method may include but is not limited to the following steps.

S1013, a second audio signal related to the second device is determined according to a first audio signal, in which the first audio signal corresponds to a first signal format, the second audio signal corresponds to a second signal format, and the first signal format, the second signal format, the first audio signal, and the second audio signal are used to test audio quality of the second device.

In this embodiment, the second audio signal related to the second device is determined according to the first audio signal, in which the first audio signal corresponds to the first signal format, the second audio signal corresponds to the second signal format, the first signal format, the second signal format, the first audio signal, and the second audio signal are used to test the audio quality of the second device, and thereby the association between the first audio signal and the second audio signal can be ensured, effectively improving the reliability in the audio quality test process.

An embodiment of the present disclosure further provides an audio quality test method, in which the first signal format includes at least one of: a channel-based signal format, an object-based signal format, or a scenario-based signal format. In this way, the applicability of the audio quality test process to different signal formats of the first signal is effectively improved.

An embodiment of the present disclosure further provides an audio quality test method, in which the second signal format includes at least one of: a channel-based signal format, an object-based signal format, or a scenario-based signal format, so that the audio quality test process can effectively address the audio signals in different formats provided by the second device, effectively improving the audio quality test effect on the second device.

FIG. 14 is a schematic flowchart of another audio quality test method according to an embodiment of the present disclosure. The audio quality test method in this embodiment is applicable to a third device. As shown in FIG. 14, the method may include but is not limited to the following steps.

S1014, an uplink audio signal sent by the second device is received.

In this embodiment of the present disclosure, when receiving the uplink audio signal sent by the second device, the signal is received through an antenna.

S2014, the uplink audio signal is processed, and the processed audio signal is output to the first device, in which the processed signal is used as the second audio signal related to the second device.

In this embodiment of the present disclosure, when the uplink audio signal is processed, decoding and rendering processing may be performed in sequence.

In this embodiment, the uplink audio signal sent by the second device is received, the uplink audio signal is processed, and the processed audio signal is output to the first device, in which the processed signal is used as the second audio signal related to the second device, so that the uplink audio signal of the second device can be effectively processed, ensuring the applicability of the second audio signal output to the first device.

It can be understood that this embodiment may be implemented alone or in combination with other embodiments of the present disclosure. For example, this embodiment may be implemented in conjunction with the embodiment shown in FIG. 13.

FIG. 15 is a schematic flowchart of another audio quality test method according to an embodiment of the present disclosure. The audio quality test method in this embodiment is applicable to a third device. As shown in FIG. 15, the method may include but is not limited to the following steps.

S1015, a first audio signal is acquired.

S2015, the first audio signal is processed to obtain a downlink audio signal.

S3015, the downlink audio signal is sent to the second device, in which the downlink audio signal is used to determine the second audio signal related to the second device.

In this embodiment, the first audio signal is obtained, the first audio signal is processed to obtain the downlink audio signal, and the downlink audio signal is sent to the second device, in which the downlink audio signal is used to determine the second audio signal related to the second device, and thereby sending the downlink audio signal by the third device to the second device can provide reliable data support for determining the second audio signal related to the second device, so as to effectively improve the association between the second audio signal and the first audio signal.

It can be understood that this embodiment may be implemented alone or in combination with other embodiments of the present disclosure. For example, this embodiment may be implemented in conjunction with the embodiment shown in FIG. 13.

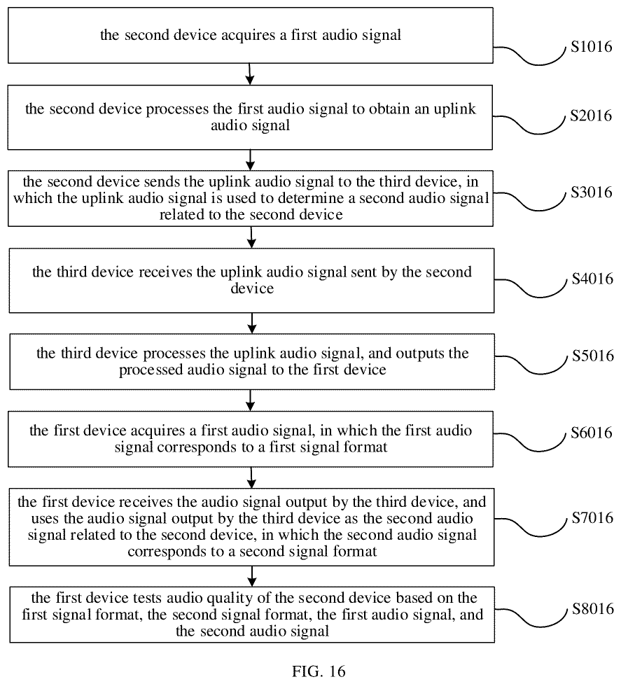

FIG. 16 is a schematic flowchart of an audio quality test method applicable to a communication system according to an embodiment of the present disclosure. The audio quality test method in this embodiment may be exemplified by interaction between a first device, a second device, and a third device, and the audio quality test method may be testing audio signal quality of an uplink of the second device. As shown in FIG. 16, the method may include but is not limited to the following steps.

S1016, the second device acquires a first audio signal.

S2016, the second device processes the first audio signal to obtain an uplink audio signal.

S3016, the second device sends the uplink audio signal to the third device, in which the uplink audio signal is used to determine a second audio signal related to the second device.

S4016, the third device receives the uplink audio signal sent by the second device.

S5016, the third device processes the uplink audio signal, and outputs the processed audio signal to the first device.

S6016, the first device acquires a first audio signal, in which the first audio signal corresponds to a first signal format.

S7016, the first device receives the audio signal output by the third device, and uses the audio signal output by the third device as the second audio signal related to the second device, in which the second audio signal corresponds to a second signal format.

S8016, the first device tests audio quality of the second device based on the first signal format, the second signal format, the first audio signal, and the second audio signal.

In this embodiment, the uplink audio signal quality of the second device is tested through the interaction between the first device, the second device, and the third device, so that the audio quality test process of the uplink is based on the signal formats of the first audio signal and the second audio signal, to adapt to the application scenario where the end-to-end audio solution is located, and effectively improve the test effect on the audio quality of the uplink of the second device.

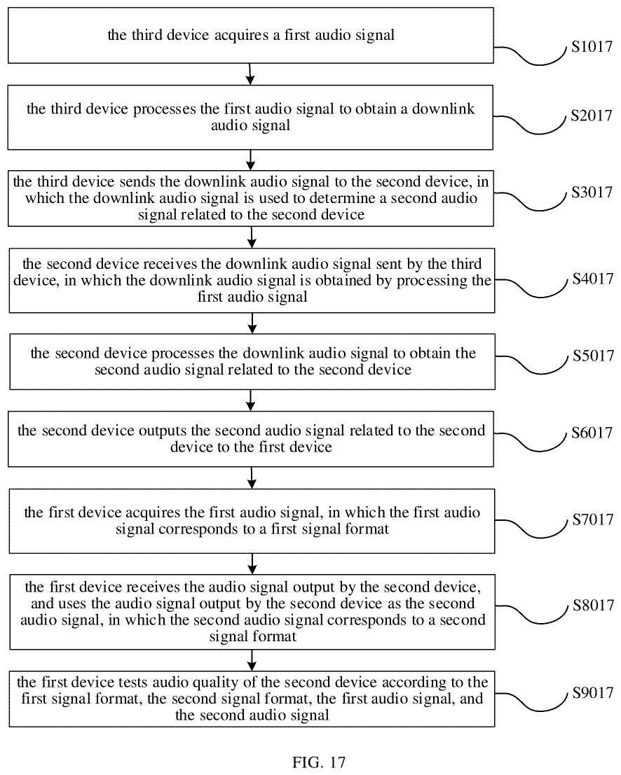

FIG. 17 is a schematic flowchart of another audio quality test method according to an embodiment of the present disclosure. The audio quality test method in this embodiment may be exemplified by interaction between a first device, a second device, and a third device, and the audio quality test method may be testing audio signal quality of a downlink of the second device. As shown in FIG. 17, the method may include but is not limited to the following steps.

S1017, the third device acquires a first audio signal.

S2017, the third device processes the first audio signal to obtain a downlink audio signal.

S3017, the third device sends the downlink audio signal to the second device, in which the downlink audio signal is used to determine a second audio signal related to the second device.

S4017, the second device receives the downlink audio signal sent by the third device, in which the downlink audio signal is obtained by processing the first audio signal.

S5017, the second device processes the downlink audio signal to obtain the second audio signal related to the second device.

S6017, the second device outputs the second audio signal related to the second device to the first device.

S7017, the first device acquires the first audio signal, in which the first audio signal corresponds to a first signal format.

S8017, the first device receives the audio signal output by the second device, and uses the audio signal output by the second device as the second audio signal, in which the second audio signal corresponds to a second signal format.

S9017, the first device tests audio quality of the second device according to the first signal format, the second signal format, the first audio signal, and the second audio signal.

In this embodiment, the downlink audio signal quality of the second device is tested through the interaction between the first device, the second device, and the third device, so that the audio quality test process of the downlink is based on the signal formats of the first audio signal and the second audio signal, to adapt to the application scenario where the end-to-end audio solution is located, and effectively improve the test effect on the audio quality of the downlink of the second device.

For example, the first audio signal may be a three-dimensional audio signal, the first device may be an analyzer device, the second device may be a terminal, the third device may be a simulator, and the audio quality test method may be divided into: a method for testing uplink three-dimensional audio quality of the terminal (the analyzer device selects an original audio signal to be played through a selected playback device) and a method for testing downlink three-dimensional audio quality of the terminal (the analyzer device selects an original audio signal to be processed and then sent by the simulator), and specific implementation steps of the two audio quality test methods may be as follows.

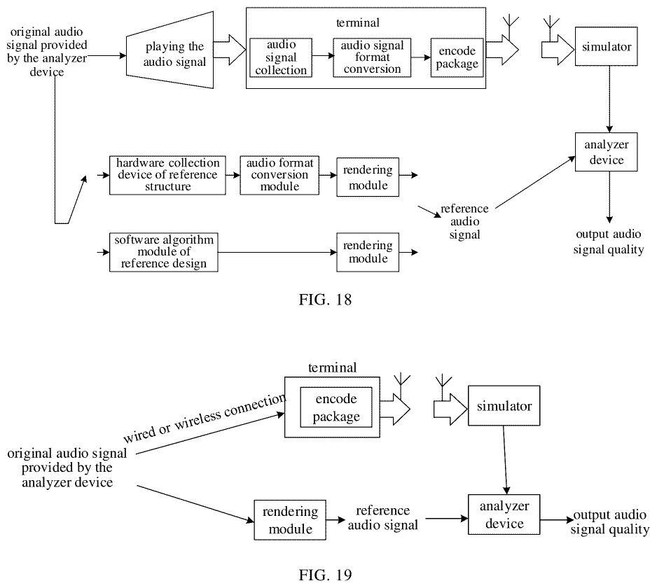

1. A method for testing the uplink three-dimensional audio quality of the terminal:
Scenario 1-1: a format of an audio signal encoded by a to-be-tested terminal is different from a format of an original audio signal, as shown in FIG. 18, which is a flowchart of an uplink test method according to an embodiment of the present disclosure.

A method for acquiring an audio signal of the to-be-tested terminal may include: the to-be-tested terminal collects an audio signal through a built-in or external audio collection device, converts the audio signal into a target format audio signal, and sends the target format audio signal through an antenna after encoding and packaging; and a simulator receives the sent signal, and decodes and renders the received sent signal to obtain the audio signal of the to-be-tested device.

A method for acquiring a reference audio signal includes: using a hardware collection device of a reference structure to collect an audio signal, converting the audio signal into a target format audio signal through a reference audio signal format conversion function module, obtaining the reference audio signal through a reference renderer, or using a software algorithm of a reference design to convert the audio signal into the target format audio signal through the reference audio signal format conversion function module, and obtaining the reference audio signal by processing through a reference rendering function module.

Calculating quality of the to-be-tested audio signal includes: the analyzer device obtains the quality of the audio signal of the to-be-tested device by comparing the audio signal of the to-be-tested device with the reference audio signal.

Scenario 1-2: the format of the audio signal encoded by the to-be-tested terminal is the same as the format of the original audio signal, as shown in FIG. 19, which is a flowchart of another uplink test method according to an embodiment of the present disclosure.

A method for acquiring an audio signal of the to-be-tested terminal may include: the to-be-tested terminal acquires the audio signal in a wired or wireless connection manner, sends the audio signal through an antenna after encoding and packaging the audio signal, the simulator receives the sent signal, and decodes and renders the received sent signal to obtain the audio signal of the to-be-tested device.

A method for acquiring a reference audio signal includes: processing, by a reference renderer, an original audio signal to obtain the reference audio signal.

Calculating quality of the to-be-tested audio signal includes: the analyzer device obtains the quality of the audio signal of the to-be-tested device by comparing the audio signal of the to-be-tested device with the reference audio signal.

2. A method for testing the downlink three-dimensional audio quality of the terminal:

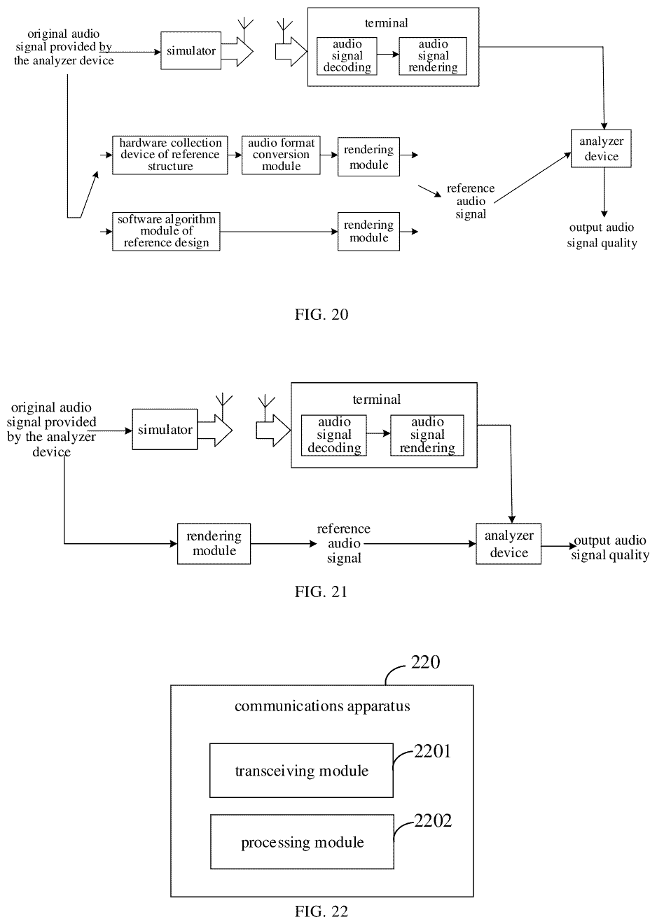

Scenario 2-1: a format of an audio signal encoded by a to-be-tested terminal is different from a format of an original audio signal, as shown in FIG. 20, which is a flowchart of a downlink test method according to an embodiment of the present disclosure.

A method for acquiring an audio signal of the to-be-tested terminal may include: the to-be-tested terminal receives an audio signal sent by a simulator, and obtain the audio signal of the to-be-tested device by unpacking, decoding and rendering the received audio signal.

A method for acquiring a reference audio signal includes: using a hardware collection device of a reference structure to collect an audio signal, converting the audio signal into a target format audio signal through a reference audio signal format conversion function module, obtaining the reference audio signal through a reference renderer, or using a software algorithm of a reference design to convert the audio signal into the target format audio signal through the reference audio signal format conversion function module, and obtaining the reference audio signal by processing through a reference rendering function module.

Calculating quality of the to-be-tested audio signal includes: the analyzer device obtains the quality of the audio signal of the to-be-tested device by comparing the audio signal of the to-be-tested device with the reference audio signal.

Scenario 2-2: the format of the audio signal encoded by the to-be-tested terminal is the same as the format of the original audio signal, as shown in FIG. 21, which is a flowchart of another downlink test method according to an embodiment of the present disclosure.

A method for acquiring an audio signal of the to-be-tested terminal may include: the to-be-tested terminal receives an audio signal sent by a simulator, and unpacks, decodes and renders the received audio signal to obtain the audio signal of the to-be-tested device.

A method for acquiring a reference audio signal includes: processing, by using a reference renderer, an original audio signal to obtain the reference audio signal.

Calculating quality of the to-be-tested audio signal includes: the analyzer device obtains the quality of the audio signal of the to-be-tested device by comparing the audio signal of the to-be-tested device with the reference audio signal.

FIG. 22 is a schematic structural diagram of a communication apparatus according to an embodiment of the present disclosure. The communications apparatus 220 shown in FIG. 22 may include a transceiving module 2201 and a processing module 2202. The transceiving module 2201 may include a transmitting module and/or a receiving module. The transmitting module is configured to implement a transmitting function, and the receiving module is configured to implement a receiving function, and the transceiving module 2201 may implement a transmitting function and/or a receiving function.

The communications apparatus 220 may be an electronic device having a test function (for example, the first device in the foregoing method embodiments), or may be an apparatus in an electronic device having a test function, or may be an apparatus that can be used by matching with an electronic device having a test function. Alternatively, the communication apparatus 220 may be a terminal (for example, the second device in the foregoing method embodiments), an apparatus in the terminal, or an apparatus that can be used by matching with the terminal. Alternatively, the communication apparatus 220 may be a network device (for example, the third device in the foregoing method embodiments), an apparatus in the network device, or an apparatus that can be used by matching with the network device.

The communications apparatus 220 is on a first device side, and the apparatus includes a transceiving module 2201 and a processing module 2202.

The transceiving module 2201 is configured to acquire a first audio signal, in which the first audio signal corresponds to a first signal format.

In an implementation, the transceiving module 2201 is further configured to acquire a second audio signal related to a second device, in which the second audio signal corresponds to a second signal format.

The processing module 2202 is configured to test audio quality of the second device according to the first signal format, the second signal format, the first audio signal, and the second audio signal.

In an implementation, the first signal format includes at least one of: a channel-based signal format; an object-based signal format; or a scenario-based signal format.

In an implementation, the second signal format includes at least one of: a channel-based signal format; an object-based signal format; or a scenario-based signal format.

In an implementation, the transceiving module 2201 is further configured to receive an audio signal output by a third device, and use the audio signal output by the third device as the second audio signal; and The audio signal output by the third device is obtained by receiving an uplink audio signal sent by the second device and processing the uplink audio signal by the third device 1.

In an implementation, the transceiving module 2201 is further configured to receive an audio signal output by the second device, and use the audio signal output by the second device as the second audio signal.

The audio signal output by the second device is obtained by receiving a downlink audio signal sent by a third device and processing the downlink audio signal by the second device.

In an implementation, the processing module 2202 is further configured to determine whether the first signal format and the second signal format are the same to obtain a determination result; process the first audio signal according to the determination result to obtain a third audio signal; and test the audio quality of the second device according to the second audio signal and the third audio signal.

In an implementation, the processing module 2202 is further configured to:
process the first audio signal to obtain the third audio signal, in response to the determination result being that the first signal format and the second signal format are the same
process the first audio signal according to the second signal format to obtain the third audio signal, in response to the determination result being that the first signal format is different from the second signal format.

In an implementation, the processing module 2202 is further configured to:
convert the first signal format of the first audio signal into the second signal format to obtain a converted audio signal; and process the converted audio signal to obtain the third audio signal.

In an implementation, the transceiving module 2201 is further configured to acquire a plurality of to-be-processed audio signals related to the first audio signal, in which the plurality of to-be-processed audio signals are obtained by collecting the first audio signal by a corresponding audio collection apparatus.

In an implementation, the processing module 2202 is further configured to perform beamforming processing on the plurality of to-be-processed audio signals to obtain an audio signal in the second signal format, and use the audio signal in the second signal format as the converted audio signal.

In an implementation, the transceiving module 2201 is further configured to acquire a format conversion matrix between the first signal format and the second signal format.

In an implementation, the processing module 2202 is further configured to convert the first signal format of the first audio signal into the second signal format according to the format conversion matrix to obtain the converted audio signal.

By implementing the method of the present disclosure, the first device can obtain the first audio signal, in which the first audio signal corresponds to the first signal format, obtain the second audio signal related to the second device, in which the second audio signal corresponds to the second signal format, and test the audio quality of the second device according to the first signal format, the second signal format, the first audio signal, and the second audio signal, so that the signal formats of the first audio signal and the second audio signal can be effectively combined in the audio quality test process to adapt to the application scenario where the end-to-end audio solution is located, effectively improving the test effect on the audio quality of the second device.

The communications apparatus 220 is on a second device side, and the apparatus includes a processing module 2202.

The processing module 2202 is configured to determine a second audio signal related to the second device based on a first audio signal, in which the first audio signal corresponds to a first signal format, the second audio signal corresponds to a second signal format, and the first signal format, the second signal format, the first audio signal, and the second audio signal are used to test audio quality of the second device.

In an implementation, the first signal format includes at least one of: a channel-based signal format; an object-based signal format; or a scenario-based signal format.

In an implementation, the second signal format includes at least one of: a channel-based signal format; an object-based signal format; or a scenario-based signal format.

The transceiving module 2201 is configured to acquire the first audio signal.

In an implementation, the processing module 2202 is further configured to process the first audio signal to obtain an uplink audio signal.

In an implementation, the transceiving module 2201 is further configured to send the uplink audio signal to a third device, in which the uplink audio signal is used to determine the second audio signal related to the second device.

In an implementation, the transceiving module 2201 is further configured to receive a downlink audio signal sent by a third device, in which the downlink audio signal is obtained by processing the first audio signal.

In an implementation, the processing module 2202 is further configured to process the downlink audio signal to obtain the second audio signal related to the second device,

In an implementation, the transceiving module 2201 is further configured to output the second audio signal related to the second device to the first device.

By implementing the method of the present disclosure, the second device can determine, according to the first audio signal, the second audio signal related to the second device, in which the first audio signal corresponds to the first signal format, the second audio signal corresponds to the second signal format, the first signal format, the second signal format, the first audio signal, and the second audio signal are used to test the audio quality of the second device, thereby effectively improving the association between the first audio signal and the second audio signal, ensuring the reliability of the audio quality test process.

The communications apparatus 220 is on a third device side, and the apparatus includes a processing module 2202.

The processing module 2202 is configured to determine a second audio signal related to a second device based on a first audio signal, in which the first audio signal corresponds to a first signal format, the second audio signal corresponds to a second signal format, and the first signal format, the second signal format, the first audio signal, and the second audio signal are used to test audio quality of the second device.

In an implementation, the first signal format includes at least one of: a channel-based signal format; an object-based signal format; or a scenario-based signal format.

In an implementation, the second signal format includes at least one of: a channel-based signal format; an object-based signal format; or a scenario-based signal format.

The transceiving module 2201 is configured to receive an uplink audio signal sent by the second device.

In an implementation, the processing module 2202 is further configured to process the uplink audio signal, and output the processed audio signal to the first device, in which the processed signal is used as the second audio signal related to the second device.

In an implementation, the transceiving module 2201 is further configured to acquire the first audio signal.

In an implementation, the processing module 2202 is further configured to process the first audio signal to obtain a downlink audio signal.

In an implementation, the transceiving module 2201 is further configured to send the downlink audio signal to the second device, in which the downlink audio signal is used to determine the second audio signal related to the second device.

By implementing the method of the present disclosure, the third device can determine, according to the first audio signal, the second audio signal related to the second device, in which the first audio signal corresponds to the first signal format, the second audio signal corresponds to the second signal format, and the first signal format, the second signal format, the first audio signal, and the second audio signal are used to test the audio quality of the second device, and therefore the association between the first audio signal and the second audio signal can be ensured, effectively improving the reliability in the audio quality test process.

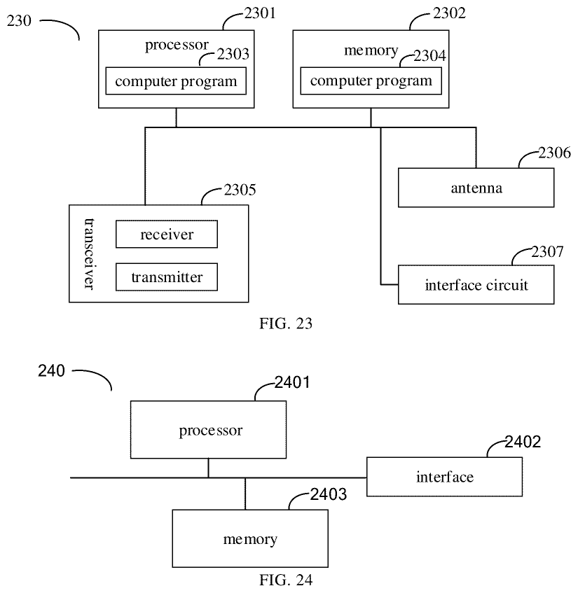

FIG. 23 is a schematic structural diagram of another communication apparatus according to an embodiment of the present disclosure. The communications apparatus 230 may be an electronic device having a test function (for example, the first device in the foregoing method embodiments), or may be a terminal (for example, the second device in the foregoing method embodiments), or may be a network device (for example, the third device in the foregoing method embodiments), or may be a chip, a chip system, a processor, or the like that supports the electronic device having the test function to implement the foregoing methods, or may be a chip, a chip system, a processor, or the like that supports the terminal to implement the foregoing methods, or may be a chip, a chip system, a processor, or the like that supports the network device to implement the foregoing methods. The apparatus may be configured to implement the methods described in the foregoing method embodiments, for details, refer to the descriptions in the foregoing method embodiments.

The communication apparatus 230 may include one or more processors 2301. The processor 2301 may be a general-purpose processor or a dedicated processor, etc. For example, it may be a baseband processor or a central processing unit. The baseband processor may be used to process the communication protocol and communication data, and the central processing unit may be used to control the communication apparatus (such as a network device, a baseband chip, a terminal, a terminal chip, a DU or a CU, etc.), execute a computer program, and process data of the computer program.

In an implementation, the communication apparatus 230 may further include one or more memories 2302, on which a computer program 2304 may be stored, and the processor 2301 executes the computer program 2304 and/or a computer program 2303, so that the communication apparatus 230 performs the methods described in the above method embodiments. In an implementation, data may also be stored in the memory 2302. The communication apparatus 230 and the memory 2302 may be provided separately or integrated together.

In an implementation, the communication apparatus 230 may further include a transceiver 2305 and an antenna 2306. The transceiver 2305 may be referred to as a transceiving unit, a transceiving machine, or a transceiving circuit, etc., and is configured to implement a transceiver function. The transceiver may include a receiver and a transmitter, the receiver may be referred to as a receiving machine or a receiving circuit, etc., and is configured to implement a receiving function; the transmitter may be referred to as a transmitting machine or a transmitting circuit, etc., and is configured to implement a transmitting function.

In an implementation, the communication apparatus 230 may further include one or more interface circuits 2307. The interface circuit 2307 is configured to receive code instructions and transmit them to the processor 2301. The processor 2301 runs the code instructions to enable the communication apparatus 230 to execute the methods described in the above method embodiments.

In an implementation, the processor 2301 may include a transceiver for implementing receiving and transmitting functions. For example, the transceiver may be a transceiver circuit, or an interface, or an interface circuit. The transceiver circuit, interface, or interface circuit for implementing the receiving and transmitting functions may be separate or integrated. The above-mentioned transceiver circuit, interface, or interface circuit may be used for reading and writing code/data, or the above-mentioned transceiver circuit, interface, or interface circuit may be used for transmitting or delivering signals.

In an implementation, the processor 2301 may store a computer program 2303, which runs on the processor 2301 and enables the communication apparatus 230 to perform the methods described in the above method embodiments. The computer program 2303 may be fixed in the processor 2301, in which case the processor 2301 may be implemented by hardware.

In an implementation, the communication apparatus 230 may include a circuit that can implement the functions of transmitting or receiving or communicating in the aforementioned method embodiments. The processor and transceiver described in the present disclosure can be implemented in an integrated circuit (IC), an analog IC, a radio frequency integrated circuit (RFIC), a mixed signal IC, an application specific integrated circuit (ASIC), a printed circuit board (PCB), an electronic device, etc. The processor and transceiver can also be manufactured using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus described in the above embodiments may be an electronic device having a test function (for example, the first device in the foregoing method embodiments), or may be a terminal (for example, the second device in the foregoing method embodiments), or may be a network device (for example, the third device in the foregoing method embodiments), but the scope of the communication apparatus described in the present disclosure is not limited thereto, and the structure of the communication apparatus may not be limited thereto. The communication apparatus may be an independent device or may be part of a larger device. For example, the communication apparatus may be:
(1) a stand-alone IC, chip, chip system or subsystem;
(2) a collection of ICs including one or more ICs, in an implementation, the collection of ICs may also include storage components for storing data and computer programs;
(3) an ASIC, such as a modem;
(4) modules that can be embedded within other devices;
(5) receivers, terminals, smart terminals, cellular phones, wireless devices, handheld machines, mobile units, in-vehicle devices, base stations, cloud devices, artificial intelligence devices, and the like; and
(6) others.

For a case that the communication apparatus may be a chip or a chip system, refer to a schematic structural diagram of the chip shown in FIG. 24. The chip shown in FIG. 24 includes a processor 2401 and an interface 2402, where the number of the processors 2401 may be one or more, and the number of the interfaces 2402 may be multiple.

For a case that the chip is configured to implement the functions of the first device in the embodiments of the present disclosure:
the processor 2401 is configured to implement S302 in FIG. 2, or is configured to implement S105 , S205, and S305 in FIG. 5, or is configured to implement S106 and S206 in FIGS. 6a and 6b;
the interface 2402 is configured to implement S102 and S202 in FIG. 2, or is configured to implement S103 in FIG. 3, or is configured to implement S104 in FIG. 4.

For a case that the chip is configured to implement the functions of the second device in the embodiments of the present disclosure:
the processor 2401 is configured to implement S1010 in FIG. 10, S2011 in FIG. 11, or S2012 in FIG. 12;
the interface 2402 is configured to implement S1011 and S3011 in FIG. 11, or is configured to implement S1012 and S3012 in FIG. 12.

For a case that the chip is configured to implement the functions of the third device in the embodiments of the present disclosure:
the processor 2401 is configured to implement S1013 in FIG. 13, S2014 in FIG. 14, or S2015 in FIG. 15;
the interface 2402 is configured to implement S1014 in FIG. 14, or is configured to implement S1015 and S3015 in FIG. 15.

In an implementation, the chip further includes a memory 2403, and the memory 2403 is configured to store necessary computer programs and data.

Those skilled in the art may also understand that the various illustrative logical blocks and steps listed in the embodiments of the present disclosure may be implemented by electronic hardware, computer software, or a combination of both. Whether such functions are implemented by hardware or software depends on the specific application and the design requirements of the entire system. Those skilled in the art may use various methods to implement the functions described for each specific application, but such implementation should not be understood as exceeding the scope of protection of the embodiments of the present disclosure.

An embodiment of the present disclosure further provides a communication system, which includes a communication apparatus serving as an electronic device (for example, the first device in the foregoing method embodiments) having a test function, a communication apparatus serving as a terminal (for example, the second device in the foregoing method embodiments), and a communication apparatus serving as a network device (for example, the third device in the foregoing method embodiments) in the foregoing embodiment of FIG. 22; or includes a communication apparatus serving as an electronic device (for example, the first device in the foregoing method embodiments) having a test function, a communication apparatus serving as a terminal (for example, the second device in the foregoing method embodiments), and a communication apparatus serving as a network device (for example, the third device in the foregoing method embodiments) in the foregoing embodiment of FIG. 23.

The present disclosure also provides a readable storage medium having instructions stored thereon, which implement the functions of any of the above method embodiments when executed by a computer.

The present disclosure also provides a computer program product, which implements the functions of any of the above method embodiments when executed by a computer.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the present disclosure may also be described as one or more, and the term “multiple” may be two, three, four or more, which is not limited in the present disclosure. In the embodiments of the present disclosure, for a sort of technical feature, technical features in this sort of technical feature are distinguished by “first”, “second”, “third”, “A”, “B”, “C” and “D”, etc., and there is no order of precedence or size between the technical features described by the “first”, “second”, “third”, “A”, “B”, “C” and “D”.

The correspondences shown in the tables in the disclosure may be configured or may be predefined. The values of information in the tables are merely examples and may be configured to other values, which are not limited by the disclosure. When configuring the correspondence between the information and the parameter, it is not necessarily required that all the correspondences illustrated in the tables must be configured. For example, the correspondences illustrated in certain rows in the tables in the disclosure may not be configured. For another example, the above tables may be adjusted appropriately, such as splitting, combining, and the like. The names of the parameters shown in the titles of the above tables may be other names that may be understood by the communication device, and the values or representations of the parameters may be other values or representations that may be understood by the communication device. Each of the above tables may also be implemented with other data structures, such as, arrays, queues, containers, stacks, linear tables, pointers, chained lists, trees, graphs, structures, classes, heaps, and Hash tables.

The term “predefine” in the disclosure may be understood as define, predefine, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

Those skilled in the art will readily appreciate other embodiments of the present disclosure after considering the specification and practicing the invention disclosed herein. The present disclosure is intended to cover any variations, uses or adaptations of the invention that follow the general principles of the present invention and include common knowledge or customary techniques in the art that are not disclosed in the present disclosure. The description and examples are to be considered exemplary only, and the true scope and spirit of the present disclosure are indicated by the following claims.

It is clearly understood by those skilled in the field to which it belongs that, for the convenience and brevity of description, the specific working processes of the systems, apparatuses, and units described above may be referred to the corresponding processes in the preceding method embodiments, and will not be repeated herein.

The above are only specific implementations of the disclosure, but the scope of protection of the disclosure is not limited thereto. Those skilled in the art familiar to this technical field may easily think of changes or substitutions in the technical scope disclosed by the disclosure, which shall be covered by the scope of protection of the disclosure. Therefore, the scope of protection of the disclosure shall be governed by the scope of protection of the attached claims.

1. An audio quality test method, performed by a first device, comprising:
acquiring a first audio signal, wherein the first audio signal corresponds to a first signal format;
acquiring a second audio signal related to a second device, wherein the second audio signal corresponds to a second signal format; and
testing audio quality of the second device according to the first signal format, the second signal format, the first audio signal, and the second audio signal.

2. The method according to claim 1, wherein the first signal format or the second signal format comprises at least one of:
a channel-based signal format;
an object-based signal format; or
a scenario-based signal format.

3. (canceled)

4. The method according to claim 1, wherein acquiring the second audio signal related to the second device comprises:
receiving an audio signal output by a third device, and using the audio signal output by the third device as the second audio signal;
wherein the audio signal output by the third device is obtained by receiving an uplink audio signal sent by the second device and processing the uplink audio signal by the third device.

5. The method according to claim 1, wherein acquiring the second audio signal related to the second device comprises:
receiving an audio signal output by the second device, and using the audio signal output by the second device as the second audio signal;
wherein the audio signal output by the second device is obtained by receiving a downlink audio signal sent by a third device and processing the downlink audio signal by the second device.

6. The method according to claim 1, wherein testing the audio quality of the second device according to the first signal format, the second signal format, the first audio signal, and the second audio signal comprises:
determining whether the first signal format and the second signal format are the same to obtain a determination result;
processing the first audio signal according to the determination result to obtain a third audio signal; and
testing the audio quality of the second device according to the second audio signal and the third audio signal.

7. The method according to claim 6, wherein processing the first audio signal according to the determination result to obtain the third audio signal comprises:
processing the first audio signal to obtain the third audio signal, in response to the determination result being that the first signal format and the second signal format are the same;
processing the first audio signal according to the second signal format to obtain the third audio signal, in response to the determination result being that the first signal format is different from the second signal format.

8. The method according to claim 7, wherein processing the first audio signal according to the second signal format to obtain the third audio signal comprises:
converting the first signal format of the first audio signal into the second signal format to obtain a converted audio signal; and
processing the converted audio signal to obtain the third audio signal.

9. The method according to claim 8, wherein converting the first signal format of the first audio signal into the second signal format to obtain the converted audio signal comprises:
acquiring a plurality of to-be-processed audio signals related to the first audio signal, wherein the plurality of to-be-processed audio signals are obtained by collecting the first audio signal by a corresponding audio collection apparatus; and
performing beamforming processing on the plurality of to-be-processed audio signals to obtain an audio signal in the second signal format, and using the audio signal in the second signal format as the converted audio signal.

10. The method according to claim 8, wherein converting the first signal format of the first audio signal into the second signal format to obtain the converted audio signal comprises:
acquiring a format conversion matrix between the first signal format and the second signal format; and
converting the first signal format of the first audio signal into the second signal format according to the format conversion matrix to obtain the converted audio signal.

11. An audio quality test method, performed by a second device, comprising:
determining, according to a first audio signal, a second audio signal related to the second device, wherein the first audio signal corresponds to a first signal format, the second audio signal corresponds to a second signal format, and the first signal format, the second signal format, the first audio signal, and the second audio signal are used to test audio quality of the second device.

12. The method according to claim 11, wherein the first signal format or the second signal format comprises at least one of:
a channel-based signal format;
an object-based signal format; or
a scenario-based signal format.

13. (canceled)

14. The method according to claim 11, wherein determining, according to the first audio signal, the second audio signal related to the second device comprises:
acquiring the first audio signal;
processing the first audio signal to obtain an uplink audio signal; and
sending the uplink audio signal to a third device, wherein the uplink audio signal is used to determine the second audio signal related to the second device.

15. The method according to claim 11, wherein determining, according to the first audio signal, the second audio signal related to the second device comprises:
receiving a downlink audio signal sent by a third device, wherein the downlink audio signal is obtained by processing the first audio signal;
processing the downlink audio signal to obtain the second audio signal related to the second device; and
outputting the second audio signal related to the second device to the first device.

16. An audio quality test method, performed by a third device, comprising:
determining, according to a first audio signal, a second audio signal related to a second device, wherein the first audio signal corresponds to a first signal format, the second audio signal corresponds to a second signal format, and the first signal format, the second signal format, the first audio signal, and the second audio signal are used to test audio quality of the second device.

17. The method according to claim 16, wherein the first signal format or the second signal format comprises at least one of:
a channel-based signal format;
an object-based signal format; or
a scenario-based signal format.

18. (canceled)

19. The method according to claim 16, wherein determining, according to the first audio signal, the second audio signal related to the second device comprises:
receiving an uplink audio signal sent by the second device; and
processing the uplink audio signal, and outputting the processed audio signal to the first device, wherein the processed audio signal is used as the second audio signal related to the second device.

20. The method according to claim 16, wherein determining, according to the first audio signal, the second audio signal related to the second device comprises:
acquiring the first audio signal;
processing the first audio signal to obtain a downlink audio signal; and
sending the downlink audio signal to the second device, wherein the downlink audio signal is used to determine the second audio signal related to the second device.

21. A first device, comprising:
a processor; and
a memory having stored therein a computer program executable by the processor;
wherein the processor is configured to perform the method according to claim 1.

22. A second device, comprising:
a processor; and
a memory having stored therein a computer program executable by the processor;
wherein the processor is configured to perform the method according to claim 11.

23. A third device, comprising:
a processor; and
a memory having stored therein a computer program executable by the processor;
wherein the processor is configured to perform the method according to claim 16.

24.-25. (canceled)
